(19) United States
(12) Patent Application Publication
(10) Pub. No.: US 2026/0067548 A1
(43) Pub. Date: Mar. 5, 2026

(54) CAMERA HOUSING WITH WIRE HARNESS

(71) Applicant: oToBrite Electronics Inc., Hsinchu (TW)

(72) Inventors: Chen-Shuo Tsai, Taichung City (TW); Dong-Jin Wu, Hsinchu County (TW)

(21) Appl. No.: 18/958,508

(22) Filed: Nov. 25, 2024

(30) Foreign Application Priority Data
Aug. 30, 2024 (CN) 202422123515.2

(51) Int. Cl. H04N 23/51

(52) U.S. Cl. CPC H04N 23/51

(57) ABSTRACT

A camera housing with wire harness is disclosed. The camera housing with wire harness includes: a hollow body, where a through hole is formed on a top surface of the hollow body, and a flange protruding outward around the through hole, wherein a groove is formed on one side of the flange; a wire harness, passing through the through hole and extending outward from the top surface of the hollow body or along the groove; and a molded decorative cover formed to cover outside of the flange and having an opening to allow the wire harness to pass through.

### FIELD OF THE INVENTION

The present invention relates to a cover mechanism, especially to a camera housing with wire harness.

### BACKGROUND OF THE INVENTION

A video camera is an electronic device used to capture still images or moving video. Generally, it includes a lens, an image sensor such as Complementary Metal-Oxide-Semiconductor (CMOS) sensor or Charge-Coupled Device (CCD) sensor, a signal processing unit, and an output interface. These components are integrally installed in a housing. Signal lines or power lines for the camera are wrapped in a wire harness and extend outward through an opening in the covering housing. The wire harness is flexible for adjusting its extension direction to meet the layout needs of the camera's external environment. However, since an outer diameter of the wire harness is relatively thick and has a certain degree of toughness, when the wire harness needs to be bent near the opening of the covering housing, it will undergo a large bending moment and may easily become brittle over time, rendering itself to disfunction. Therefore, cameras with different installation requirements have different outlet directions for wire harness (usually along the direction perpendicular to the housing or flat against the housing), which need to be determined before the cameras are manufactured.

For a specific model of camera, wires used in the wire harness (including the type, quantity and material of signal lines or power lines) remain unchanged. Therefore, the production of existing wire harnesses only requires to use various wire harness units and to control the outlet directions of the various wire harness units after they come out of the covering housing. The wire harness unit has a smaller housing that is independent from the camera housing, and these two housings can be screwed or welded together. However, cameras with different wire harness angles require the use of different molds to produce wire harness units, which increases mold costs. In addition, the wire harness and the covering housing are integrally formed, and thus one model of the covering housing can have only one outlet direction in cooperation with a specific wire harness unit. The production of the covering housing can be combined with a mold insert to adjust the outlet direction, but this increases the production time and cost.

In order to reduce the production cost of the current fixed connection between the camera housing and the wiring harness and to make products more competitive, the present invention is proposed.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims. The following presents a simplified summary of one or more aspects of the present disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

To meet the requirements mentioned above, the present invention provides a camera housing with wire harness. The camera housing with wire harness includes: a hollow body, provided with a through hole on a top surface thereof and a flange protruding outward around the through hole with a groove formed on one side of the flange; a wire harness, passing through the through hole and extending outward from the top surface of the hollow body or along the groove; and a molded decorative cover, for covering the flange, provided with an opening for the wire harness to pass through.

Preferably, an inner side of the flange is provided with a plurality of ribs at intervals for fixing the wire harness.

Preferably, a gap is formed between the adjacent ribs for accommodating filling material during formation of the molded decorative cover.

Preferably, the molded decorative cover is formed by secondary molding to cover the flange and is made of the filling material.

Preferably, the groove has a gradually increasing width upwardly, for easy flow down of the filling material into the hollow body.

Preferably, the hollow body and the molded decorative cover are made of different thermoplastic or thermosetting materials, and the filling material comprises thermoplastic plastics, thermosetting plastics or bonding glues.

Preferably, the molded decorative cover has an upper surface and a side surface, either of which is provided with an opening.

Preferably, the upper surface is parallel with the through hole, and the side surface is perpendicular to the through hole.

Preferably, the groove has an arc bottom section and two straight sections above the arc bottom section.

In one embodiment, the wire harness is clamped between the two straight sections when it extends outward along the groove, thereby fixing the outlet direction of the wire harness.

The flange design of the present invention can fix the wire harness in different outlet directions. Since the wire harness opening on the molded decorative cover can be positioned using mold inserts in the same mold, mold production is more economical than using two molds to make a single wire harness. The width above the groove of the flange gradually increases. When the decorative cover is injection molded, the filling material can be filled up to the wire harness and the flange, resulting in better coverage. Therefore, the present invention is superior to the prior art in terms of mold manufacturing cost and process reduction.

### BRIEF DESCRIPTION OF THE DRAWINGS

FIG. 1 is a perspective view of camera housing with wiring harness according to a first embodiment of the present invention.

FIG. 2 is a partially exploded view of the camera housing with wiring harness.

FIG. 3 is a perspective view of a hollow body.

FIG. 4 is a perspective view of another camera housing with wiring harness according to a second embodiment of the present invention.

FIG. 5 is a partially exploded view of the camera housing with wiring harness.

### DETAILED DESCRIPTION OF THE PREFERRED EMBODIMENTS

The present invention will now be described more specifically with reference to the following embodiments. The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

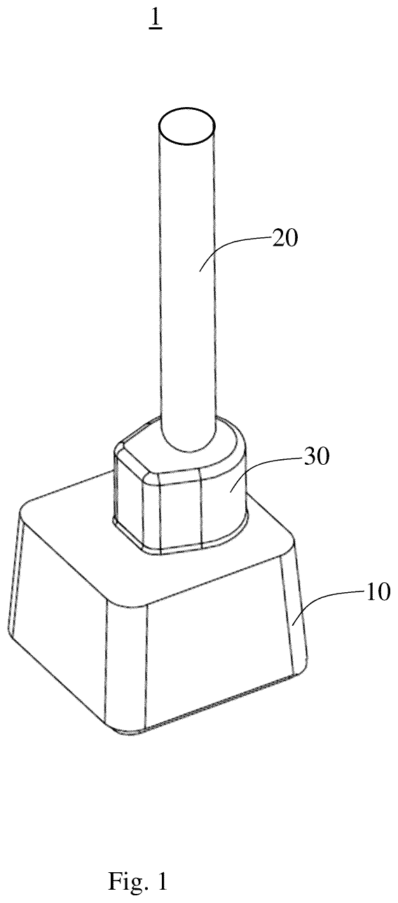

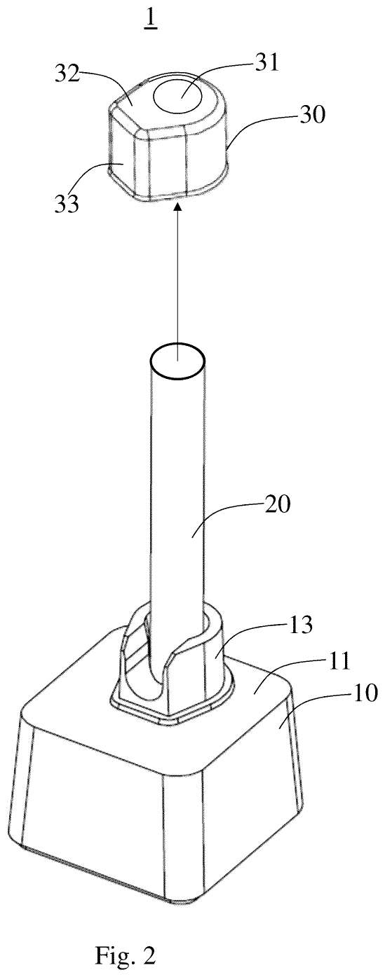

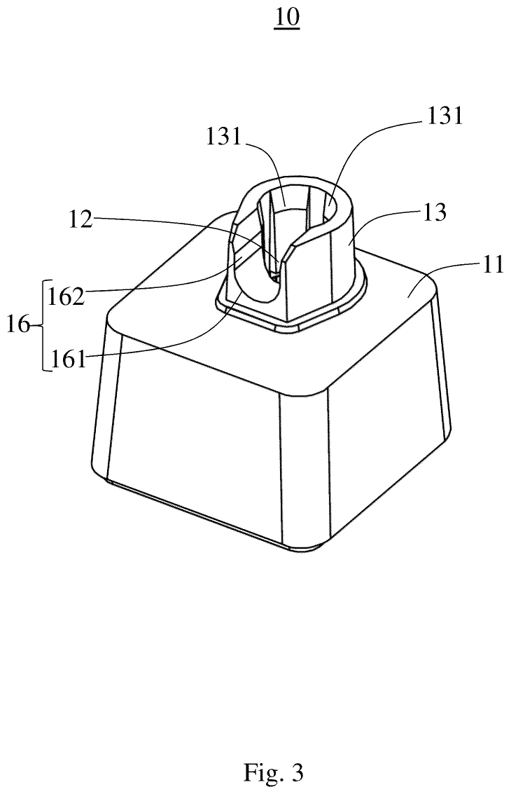

Please refer to FIGS. 1 to 3. FIG. 1 is a perspective view of a camera housing 1 with wiring harness according to a first embodiment of the present invention. FIG. 2 is a partially exploded view of the camera housing 1 with wiring harness. FIG. 3 is a perspective view of a hollow body 10 of the camera housing 1 with wiring harness. The camera housing 1 includes the above-mentioned hollow body 10, a wire harness 20, and a modeled decorative cover 30. The camera housing 1 with the wiring harness is a part of a video camera and is used to protect electronic components, such as image sensors, signal processors, circuit boards, etc., and to provide external electrical and/or signal connections for the video camera. The aforementioned components will be described in detail below with reference to the drawings.

The hollow body 10 is the main part for covering the electronic components of the video camera. In practice, the hollow body 10 mentioned in various embodiments of the present invention can be made of any plastic material, such as a thermoplastic material or a thermosetting material, without limitation to plastic. It can be made from several different materials to meet different needs and functional requirements. The most common materials are plastics, including polycarbonate (PC), which is suitable for providing good protection due to its high impact resistance; Nylon, which is often used to enhance durability due to its high strength and heat resistance; and acrylonitrile-butadiene-styrene (ABS) for its easy processability and good strength and toughness. For some high-end or professional equipment, metallic materials such as zinc alloy or aluminum alloy may be used, which provide additional durability and heat dissipation. It may also be rubber or silicone to provide water and dust resistance and increase friction during plugging/unplugging to prevent slippage. In this embodiment, it is made of ABS, which has the advantages of being light-weighed, strong, rust-proof, and easy to produce. It should be noted that the outlook of the hollow body 10 in FIGS. 1 to 3 is only an illustration and is not intended to limit the present invention. As shown in FIG. 3, a top surface 11 of the hollow body 10 (in this embodiment, an upper surface of the hollow body 10) is formed with a through hole 12. In this embodiment, the through hole 12 is circular, but the present invention is not limited to the circular through hole 12. A flange 13 is formed around the through hole 12 and protrudes outward. Since the flange 13 surrounds the space above the through hole 12, part of the outer edge of the flange 13 is arc-shaped, which looks like a horseshoe shape when viewed from above. The flange 13 also has a groove 16. The groove 16 in this embodiment has a hollowed-out U-shape. However, it can be any shape and is not limited to a U-shape. The groove 16 in this embodiment includes an arc bottom section 161 and two straight sections 162 above the arc bottom section 161. An inner side of the flange 13 is provided with a plurality of ribs 131 formed at intervals for fixing the wire harness 20. There is a gap between adjacent ribs 131 for accommodating the filling material during secondary molding to form the molded decorative cover 30. In this embodiment of the present application, there are four ribs 131, which are spaced apart respectively and surround the wire harness 20 (one of them blocked by the flange 13 and not shown in the drawings). According to the present invention, the number of the ribs 131 is not limited, and their distribution pattern inside the flange 13 is not limited either. Although the ribs 131 in FIG. 3 are perpendicular to the top surface 11, in practice they may be at an angle other than 90 degrees with the top surface 11.

The wire harness 20 is an assembly of multiple signal lines and/or power lines and is covered with a non-conductive material. For convenience of explanation, only a section of the wire harness 20 is shown in the figure for representation. In practice, the length of the wire harness 20 may be several times to dozens of times relative to the size of the hollow body 10. According to the present invention, the wire harness 20 can extend outward from the top surface 11 of the hollow body 10 or along the groove 16 after passing through the through hole 12. In this embodiment, the outlet direction of the wire harness 20 is perpendicular to the hollow body 10, and thus the wire harness 20 extends outward from the top surface 11 as shown in the lower part of FIG. 2.

The molded decorative cover 30 is used to fix the part of the wire harness 20 that leaves the flange 13, protect this part of the wire harness 20 and ensure that the outlet direction of the wire harness 20 remains unchanged, and is also used to prettify the outlook of the camera. The molded decorative cover 30 is formed by secondary molding to cover the outside of the flange 13. As shown in FIG. 2, the molded decorative cover 30 has an opening 31 to allow the wire harness 20 to pass through (along the arrow direction). Like the hollow body 10, the molded decorative cover 30 is also made of thermoplastic plastic, and the two materials can be the same. In this embodiment, since the hollow body 10 is the main part used to cover the electronic components of the camera, it is generally made of relatively strong and durable materials, and its cost is relatively expensive. In contrast, the molded decorative cover 30 is used for fixing the wire harness 20 and for covering the flange 13, and thus it can be made of lower-cost thermoplastic or thermosetting plastic. In this embodiment, since the molded decorative cover 30 is formed by secondary molding to cover the outside of the flange 13, the molded decorative cover 30 and the flange 13 are welded together. However, the molded decorative cover 30 can also be made in an independent molding manner and then screwed together with the flange 13. When the molded decorative cover 30 is formed to cover the outside of the flange 13 by secondary molding, a mold for forming the molded decorative cover 30 will be covered on the flange 13, and the filling material will be poured through the opening of the mold. The filling material will be filled inward from the groove 16 into the hollow body 10 along the gaps between the ribs 131. Finally, the filling material will overflow from the flange 13 and fill the entire internal space of the mold until the filling material is fully cooled. After solidification and molding, the mold is removed, and the molded decorative cover 30 is formed to cover the outside of the flange 13. Since the molded decorative cover 30 is made of poured filling material and all the gaps and grooves 16 of the hollow body 10 are filled with the filling material, the molded decorative cover 30 will be tightly combined with the flange 13 into a sealed state. Therefore, this molding not only effectively improves the overall waterproofness and prevents moisture and/or water vapor from penetrating through the gaps caused by screw locking, but also eliminates the need for seals, such as sealing rings, thereby effectively reducing the overall manufacturing costs. Herein, the filling material may be thermoplastic plastics, thermosetting plastics or bonding glues. In order to smoothly inject the filling material, the width above the groove 16 is gradually increased, so that the filling material is filled from the top of the groove 16 through the gap between the wire harness 20 and the flange 13 into the space between the wire harness 20 and the flange 13 and into the hollow body 10.

The molded decorative cover 30 has an upper surface 32 and a side surface 33. The upper surface 32 or the side surface 33 is provided with an opening 31. In this embodiment, the opening 31 is provided in the upper surface 32. In order to facilitate passage of the wire harness 20, the upper surface 32 in this embodiment of the present invention is parallel to the top surface 11 where the through hole 12 is located, and the side surface 33 is perpendicular to the top surface 11 where the harness through hole 12 is located.

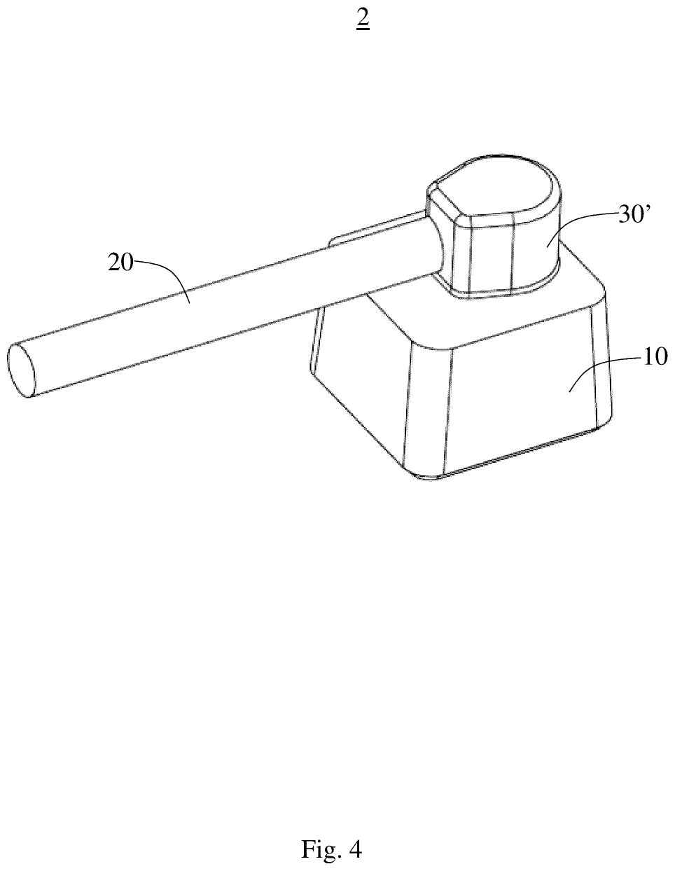

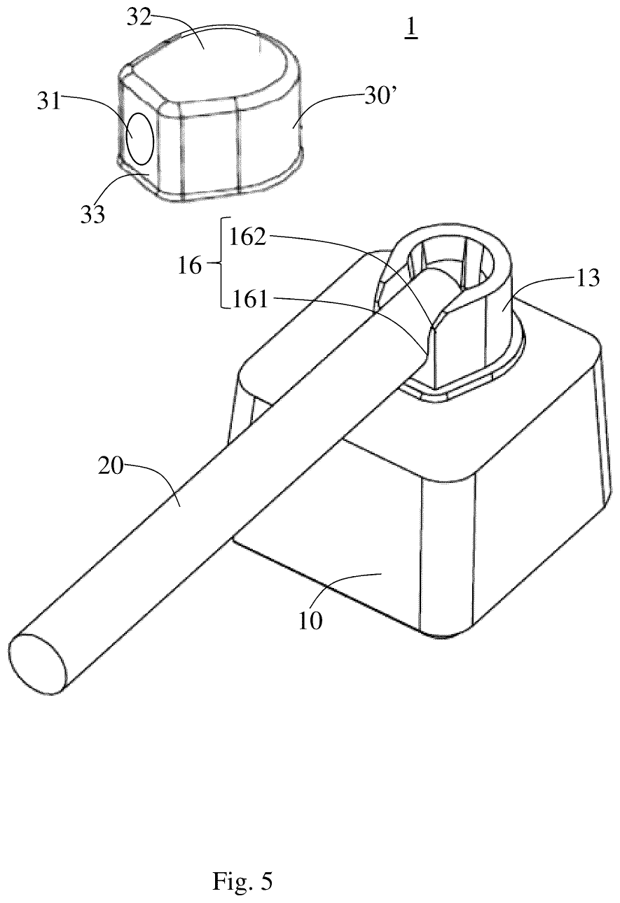

Please refer to FIGS. 4 and 5. FIG. 4 is a perspective view of another camera housing 2 with wire harness according to a second embodiment of the present invention. FIG. 5 is a partial exploded view of the camera housing 2 with wire harness. Like the previous embodiment, the camera housing 2 with wire harness in this embodiment includes a hollow body 10 and a wire harness 20, and the relevant description is omitted herein. The difference between the second embodiment and the first embodiment is that the camera housing 2 with wire harness includes a molded decorative cover 30′ instead of the molded decorative cover 30, and the outlet direction of the wire harness 20 is also different (parallel to the top surface 11 of the hollow body 10).

The molded decorative cover 30′ of this embodiment is also formed to cover the outside of a flange 13 of the hollow body 10. An opening 31 is not provided on an upper surface 32 but on a side surface 33. In this case, the wire harness 20 is restricted to pass through a groove 16 and leave the molded decorative cover 30′ from the side surface 33 of the molded decorative cover 30′ in an outlet direction parallel to the top surface 11 of the hollow body 10. When the wire harness 20 extends outward along the groove 16, it is clamped between two straight sections 162, thereby fixing the outlet direction of the wire harness 20. The molded decorative cover 30′ of this embodiment and the molded decorative cover 30 of the previous embodiment can be made using the same plastic injection mold. It is only necessary to adjust the mold insert to seal the opening 31 on the upper surface 32 or the side surface 33. The present invention utilizes one mold to achieve the functions of two molds required for the traditional production of a single wire harness.

It is to be understood that the specific order or hierarchy of steps in the methods disclosed is an illustration of exemplary processes and may be rearranged based upon design preferences. The accompanying method claims present elements of the various steps in a sample order, and are not meant to be limited to the specific order or hierarchy presented unless specifically recited therein.

Although embodiments have been described herein with respect to particular configurations and sequences of operations, it should be understood that alternative embodiments may add, omit, or change elements, operations and the like. Accordingly, the embodiments disclosed herein are meant to be examples and not limitations.

What is claimed is:

1. A camera housing with wire harness, comprising:
a hollow body, provided with a through hole on a top surface thereof and a flange protruding outward around the through hole with a groove formed on one side of the flange;
a wire harness, passing through the through hole and extending outward from the top surface of the hollow body or along the groove; and
a molded decorative cover, for covering the flange, provided with an opening for the wire harness to pass through.

2. The camera housing with wire harness according to claim 1, wherein an inner side of the flange is provided with a plurality of ribs at intervals for fixing the wire harness.

3. The camera housing with wire harness according to claim 2, wherein a gap is formed between the adjacent ribs for accommodating filling material during formation of the molded decorative cover.

4. The camera housing with wire harness according to claim 3, wherein the molded decorative cover is formed by secondary molding to cover the flange and is made of the filling material.

5. The camera housing with wire harness according to claim 3, wherein the groove has a gradually increasing width upwardly, for easy flow down of the filling material into the hollow body.

6. The camera housing with wire harness according to claim 3, wherein the hollow body and the molded decorative cover are made of different thermoplastic or thermosetting materials.

7. The camera housing with wire harness according to claim 3, wherein the filling material comprises thermoplastic plastics, thermosetting plastics or bonding glues.

8. The camera housing with wire harness according to claim 1, wherein the molded decorative cover has an upper surface and a side surface, either of which is provided with an opening.

9. The camera housing with wire harness according to claim 8, wherein the upper surface is parallel with the through hole, and the side surface is perpendicular to the through hole.

10. The camera housing with wire harness according to claim 1, wherein the groove has an arc bottom section and two straight sections above the arc bottom section.

11. The camera housing with wire harness according to claim 10, wherein the wire harness is clamped between the two straight sections when it extends outward along the groove, thereby fixing the outlet direction of the wire harness.
